(19) United States
(12) Patent Application Publication
(10) Pub. No.: US 2012/0295153 A1
(43) Pub. Date: Nov. 22, 2012

(54) BATTERY PACK

(76) Inventor: Jeong-Deok BYUN, Yongin-si (KR)

(21) Appl. No.: 13/338,199

(22) Filed: Dec. 27, 2011

(30) Foreign Application Priority Data
May 19, 2011 (KR) 10-2011-0047464

(51) Int. Cl. H01M 2/30

(52) U.S. Cl. 429/179

(57) ABSTRACT

A battery pack includes a battery unit including a battery cell and a lead tab extending from the battery cell; a frame case supporting the battery unit and including a first support portion supporting the battery cell and a second support portion supporting the lead tab; and a first coupling member passing through the lead tab and extending toward the second support portion, and a coupling hole accommodating the first coupling member is formed in the second support portion, the coupling hole being configured to receive a second coupling member that is mechanically coupleable to the first coupling member.

### CROSS-REFERENCE TO RELATED APPLICATION

This application claims priority to and the benefit of Korean Patent Application No. 10-2011-0047464, filed on May 19, 2011 in the Korean Intellectual Property Office, the entire content of which is incorporated herein by reference.

### BACKGROUND

1. Field

Aspects of embodiments of the present invention relate to a battery pack.

2. Description of the Related Art

Secondary batteries are applied to a variety of technical fields across industry due to their diversity and advantages. For example, secondary batteries are widely used as an energy source for mobile electronic devices such as digital cameras, cellular phones, and notebook computers, as well as for hybrid electric vehicles and electric vehicles for preventing or reducing air pollution caused by current gasoline and diesel engines using fossil fuels. Secondary batteries may be packaged by being accommodated in a pack case and provided in a form of a battery pack.

### SUMMARY

According to an aspect of embodiments of the present invention, a battery pack includes a coupling structure to collectively combine constituent elements of the battery pack, and having increased repairability.

Additional aspects of embodiments of the present invention will be set forth, in part, in the description which follows and, in part, will be apparent from the description, or may be learned by practice of embodiments of the present invention.

According to an embodiment of the present invention, a battery pack includes a battery unit including a battery cell and a lead tab extending from the battery cell; a frame case supporting the battery unit and including a first support portion supporting the battery cell and a second support portion supporting the lead tab; and a first coupling member passing through the lead tab and extending toward the second support portion, and a coupling hole accommodating the first coupling member is formed in the second support portion, the coupling hole being configured to receive a second coupling member that is mechanically coupleable to the first coupling member.

The first coupling member may have a rotational coupling structure that is coupleable to the second coupling member by rotation with respect to a coupling axis.

The coupling hole may have a polygonal shape to restrict rotation of the second coupling member.

The coupling hole may have a polygonal shape corresponding to a shape of the second coupling member.

The coupling hole may have a hexagonal shape.

The battery pack may further include a terminal member and a holder case, respectively contacting opposite surfaces of the lead tab, and arranged on the second support portion, and the first coupling member may be insertable in the coupling hole of the second support portion by passing through the holder case, the lead tab, and the terminal member.

The first coupling member may extend to sequentially pass through the holder case, the lead tab, and the terminal member.

The first support portion may include a metal, and the second support portion may include a resin-based material, and the first and second support portions may be integrally formed with each other.

According to another embodiment of the present invention, a battery pack includes a battery unit including a battery cell and a lead tab extending from the battery cell; a frame case supporting the battery unit and including a first support portion supporting the battery cell and a second support portion supporting the lead tab; and a first coupling member passing through the lead tab and coupling the lead tab and the second support portion, and a coupling hole accommodating the first coupling member is formed in the second support portion, the coupling hole having a shape corresponding to a shape of a second coupling member that is mechanically coupleable to the first coupling member.

The first coupling member may have a rotational coupling structure that is coupleable to the second coupling member by rotation with respect to a coupling axis.

The coupling hole may have a polygonal shape to restrict rotation of the second coupling member.

The coupling hole may have a hexagonal shape.

The battery pack may further include a terminal member and a holder case, respectively contacting opposite surfaces of the lead tab, and arranged on the second support portion, and the first coupling member may be insertable in the coupling hole of the second support portion by passing through the holder case, the lead tab, and the terminal member.

The first coupling member may extend to sequentially pass through the holder case, the lead tab, and the terminal member.

The first support portion may include a metal, and the second support portion may include a resin-based material, and the first and second support portions may be integrally formed with each other.

### BRIEF DESCRIPTION OF THE DRAWINGS

The above and other aspects of embodiments of the present invention will become more readily apparent from the following description of some exemplary embodiments, taken in conjunction with the accompanying drawings thereof, of which:

FIG. 1 is an exploded perspective view of a battery pack according to an embodiment of the present invention;

FIG. 2 is a partially exploded perspective view of the battery pack of FIG. 1;

FIG. 3 is a cross-sectional view of a battery unit of the battery pack of FIG. 1, taken along the line

FIG. 4 is a bottom perspective view of a holder case of the battery pack of FIG. 1;

FIG. 5 is a perspective view of a portion of the battery pack of FIG. 1, shown in an upright orientation;

FIG. 6 is a partially exploded bottom perspective view of the battery pack of FIG. 1;

FIG. 7 is a detailed bottom perspective view of the region VII of FIG. 6; and

FIG. 8 is a bottom view of a portion of the battery pack of FIG. 1.

### DETAILED DESCRIPTION

In the following detailed description, some exemplary embodiments of the present invention are shown and described, by way of illustration. As those skilled in the art would realize, the described embodiments may be modified in various different ways, all without departing from the spirit or scope of the present invention. Accordingly, the drawings and description are to be regarded as illustrative in nature and not restrictive.

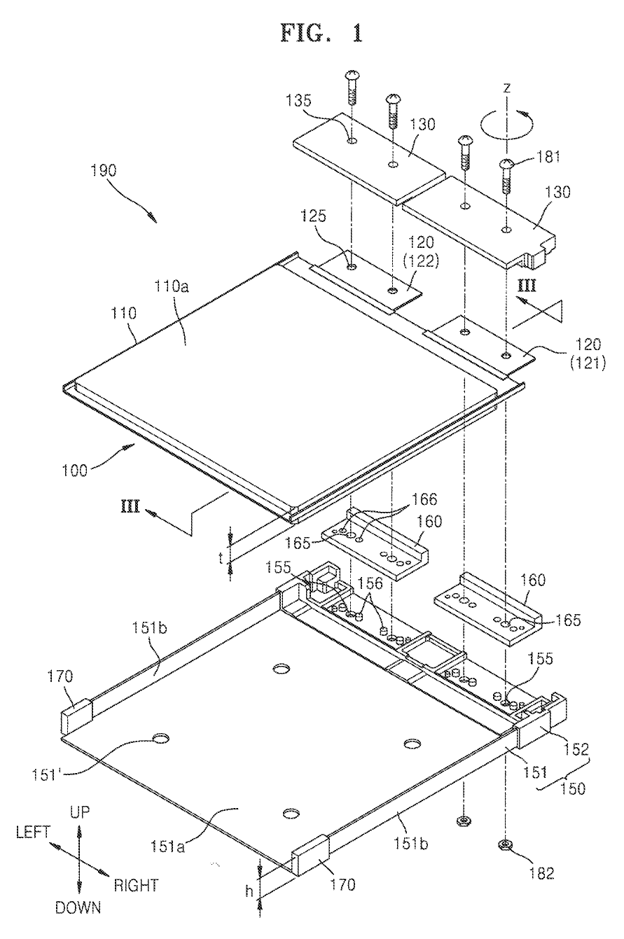

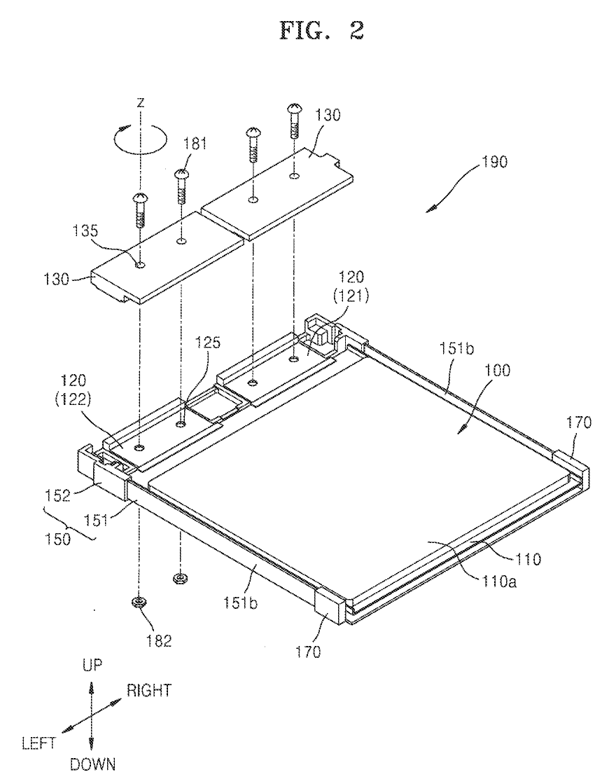

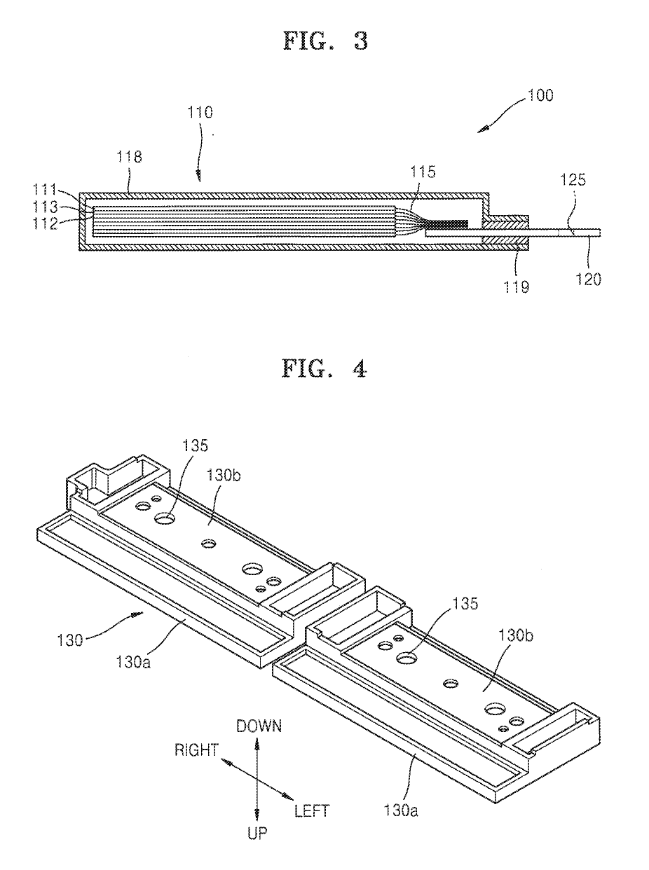

FIGS. 1 and 2 are exploded and partially exploded perspective views, respectively, of a battery pack 190 according to an embodiment of the present invention. FIG. 3 is a cross-sectional view of a battery unit 100 of the battery pack 190 taken along the line III-III of FIG. 1. Referring to FIGS. 1 through 3, the battery pack 190 includes a battery unit 100 and a frame case 150 for accommodating the battery unit 100.

The battery unit 100 is a rechargeable secondary battery and, in one embodiment, may be configured as a Li-ion battery, for example. The battery unit 100, in one embodiment, includes a battery cell 110 and a lead tab 120 electrically connected to the battery cell 110 and drawn from the battery cell 110.

Referring to FIG. 3, the battery cell 110 may include an electrode assembly in which, for example, a positive plate 111, a separator 113, and a negative plate 112 are sequentially stacked. A plurality of the positive plates 111, the separators 113, and the negative plates 112 may be stacked to provide the battery cell 110 having high output and high capacity. An electrode assembly in which the positive plate 111 and the negative plate 112 are stacked with the separator 113 interposed therebetween is sealed in a pouch 118.

Although not illustrated in the drawing, the positive plate 111 may be formed by coating a positive active material on a surface of a positive collector (not shown), and the negative plate 112 may be formed by coating a negative active material on a surface of a negative collector (not shown).

An electrode tab 115 may be electrically connected to each of the positive plate 111 and the negative plate 112. A plurality of electrode tabs 115 drawn from the positive plate 111 and the negative plate 112 which are stacked on each other are overlapped with each other. The electrode tabs 115 which are gathered close to each other are electrically connected to the lead tab 120. For example, the electrode tabs 115 and the lead tab 120 may be coupled to each other by a method such as ultrasonic welding.

The lead tab 120 forms an external connection structure of the battery cell 110 and is drawn from the battery cell 110 to guide current from the battery cell 110 to the outside of the battery cell 110. In one embodiment, the lead tab 120 is partially drawn outside the pouch 118, and an insulation member 119 may be interposed between the lead tab 120 and the pouch 118 to provide insulation.

The lead tab 120 may be formed of a metal material exhibiting high conductivity, such as nickel (Ni), aluminum (Al), copper (Cu), etc. As illustrated in FIG. 1, the lead tab 120 may include first and second lead tabs 121 and 122 having opposite polarities. The first and second lead tabs 121 and 122 may be electrically connected to the positive plate 111 and the negative plate 112, respectively.

The battery cell 110 may be electrically connected to an external load or an external power supply apparatus via the lead tab 120. That is, charge/discharge current of the battery cell 110 may be output to the external load or input from the external power supply apparatus by way of the lead tab 120.

Since the charge/discharge current concentrates on the lead tab 120, it is preferable to reduce electrical resistance in view of discharge efficiency. Accordingly, the lead tab 120 may be formed of a metal material having a low electrical resistance, such as nickel (Ni), aluminum (Al), copper (Cu), etc.

One or more coupling holes 125 for electrical connection with a terminal member 160 may be formed in the lead tab 120. The coupling holes 125 may be formed at a position spaced (e.g., by a predetermined distance) from an edge of the lead tab 120. The coupling holes 125 may be formed in a pair at positions spaced from opposite side ends of the lead tab 120.

The battery unit 100 is assembled on and supported by the frame case 150. The battery unit 100 and the frame case 150 are assembled to each other in a direction facing each other.

The frame case 150, in one embodiment, includes a first support portion 151 for accommodating and supporting the battery cell 110 and a second support portion 152 for accommodating and supporting the lead tab 120 drawn from the battery cell 110. The frame case 150 may have both a function of protecting the battery unit 100 from an external shock and a function as a heat dissipation plate for dissipating operation heat generated during charge/discharge operations of the battery unit 100. In one embodiment, the first support portion 151 may be formed of a metal material having mechanical strength and exhibiting high heat conductivity, such as aluminum (Al), etc.

The first support portion 151 may have a generally flat plate shape as a whole. A pair of ribs 151b having a bent shape (e.g., bent at an angle from an overall flat plate portion of the first support portion 151) may be formed at opposite side edges of the first support portion 151 to cover sides of the battery cell 110. That is, in one embodiment, the first support portion 151 may include a main body portion 151a having a plate shape and the ribs 151b forming wing portions at both sides of the main body portion 151a. The ribs 151b may be bent from the main body portion 151a and may be integrally formed with the main body portion 151a. The main body portion 151a of the first support portion 151 supports a main surface of the battery cell 110 (e.g., a lower surface of upper and lower surfaces in the drawings). The ribs 151b may extend laterally to cover the lateral surfaces of the battery cell 110. The first support portion 151, in one embodiment, has a structure to substantially encompass the battery cell 110 to protect the battery cell 110 that has a relatively low strength and insulate the battery cell 110 from an external environment.

A spacer 170 may be formed on the rib 151b. The spacer 170 may be formed integrally with the case frame 150, such as during injection formation of the case frame 150. The spacer 170 may be formed of an insulation resin material, such as a polymer resin material (e.g., polyphenylene sulfide (PPS)), and may be provided in injection molding of a polymer resin material. The spacer 170 may be formed with the first support portion 151 of the case frame 150. For example, the case frame 150 in a mixed form of the first support portion 151 of a metal material and the spacer 170 of a resin material may be obtained using injection formation of hetero-materials.

The spacer 170, in one embodiment, provides a space (e.g., a predetermined allowance space) between neighboring battery packs 190 adjacent one another in a stacking direction, such as in a battery module (not shown) in which the battery packs 190 are electrically combined using the battery pack 190 as one assembly unit. For example, in one embodiment, a height “h” of the spacer 170 is greater than a thickness “t” of the battery cell 110.

In one embodiment, to provide a battery module of high output and high capacity, the battery cells 110 are stacked parallel to each other and electrically connected to each other serially or in parallel to form a battery module, using the battery cell 110 supported on the case frame 150 as one unit. A predetermined allowance space may be secured between the battery cells 110 stacked on each other due to the spacer 170 around the battery cell 110. The neighboring battery cells 110 adjacent one another in a stacking direction may be stacked with an allowance space interposed therebetween. An allowance for swelling of the battery cell 110 that may be generated during the charge/discharge operation may be provided by the allowance space. Further, since heat of the battery cell 110 may be exhausted through the allowance space, heat dissipation of the battery cell 110 may be facilitated.

One or more vent holes 151′ for heat dissipation may be formed in the first support portion 151. In one embodiment, the operation heat generated according to the charge/discharge operation of the battery cell 110 may be distributed using low-temperature air introduced through the vent hole 151′.

The first support portion 151, in one embodiment, is formed in an outwardly open shape. Accordingly, an upper surface 110a of the main surfaces of the battery cell 110 accommodated in the first support portion 151 is exposed outwardly and the operation heat generated from the battery cell 110 may be dissipated to the outside. That is, the main body portion 151a of the first support portion 151 supports the battery cell 110 through the lower surface of the main surfaces of the battery cell 110. While the rib 151b of the first support portion 151 protects and covers a side surface of the battery cell 110, the upper surface 110a of the battery cell 110 is exposed to the outside.

The second support portion 152 accommodates the lead tab 120 drawn from the battery cell 110. The second support portion 152 accommodates the lead tab 120 with the terminal member 160 interposed therebetween, and the lead tab 120 may be accommodated on the terminal member 160. In one embodiment, a through coupling member 181 is coupled to the terminal member 160 by penetrating the lead tab 120, and the lead tab 120 and the terminal member 160 are coupled to each other. In one embodiment, a thread (not shown) for screw coupling to the through coupling member 181 may be formed in a coupling hole 165 of the terminal member 160. In one embodiment, a coupling hole 155 of the second support portion 152 is formed at a position corresponding to the coupling holes 125 and 165 of the lead tab 120 and the terminal member 160.

To insulate the terminal member 160 from an external environment and to prevent or substantially prevent an electrical short-circuit, the second support portion 152 may be formed of an insulation material, such as a polymer resin material (e.g., PPS), and may be provided by injection molding of a polymer resin material. The second support portion 152 and the first support portion 151 may be integrally formed through injection molding of hetero-materials. Through injection molding of hetero-materials, the frame case 150 may be made in which the first support portion 151 of a metal base and the second support portion 152 of a resin base are integrally formed.

The terminal member 160 may be assembled on the second support portion 152. For example, the terminal member 160 may be fixed on the second support portion 152. In the assembly of the terminal member 160 and the second support portion 152, the terminal member 160 may be integrally formed on the second support portion 152. For example, the terminal member 160 may be integrally formed with the second support portion 152 during the formation of the second support portion 152. In one embodiment, the second support portion 152 may be formed by injection molding. The second support portion 152 integrally formed with the terminal member 160 may be obtained by placing the terminal member 160 together in an injection mold (not shown) during the injection molding of the second support portion 152, injecting raw material paste (not shown) in the injection mold, and curing the raw material paste.

In one embodiment, a fixing hole 166 for coupling with the second support portion 152 may be formed in the terminal member 160. In one embodiment, a fixing protrusion 156 protruding from the second support portion 152 is inserted in the fixing hole 166 of the terminal member 160, and the terminal member 160 and the second support portion 152 are thereby coupled to each other. In one embodiment, the fixing protrusion 156 may be formed by injecting the raw material paste in the fixing hole 166 of the terminal member 160 during the injection molding of the second support portion 152.

The fixing hole 166 formed in the terminal member 160 may be formed at a position adjacent to the coupling hole 165. In one embodiment, as illustrated in the drawings, a pair of the fixing holes 166 may be formed at opposite sides of the coupling hole 165. The fixing protrusion 156 may be provided on the second support portion 152 at a position corresponding to the fixing hole 166. In one embodiment, a pair of the fixing protrusions 156 may be formed at opposite sides of the coupling hole 155 and at positions corresponding to the pair of fixing holes 166.

The terminal member 160 makes an electrical connection to the lead tab 120 and relays charge/discharge current passing the perimeter of the frame case 150. For example, the current generated from the battery cell 110 may pass through the lead tab 120 and may be drawn to the outside of the battery pack 190 via the terminal member 160 that is electrically connected to the lead tab 120.

The terminal member 160 may make surface contact with the lead tab 120, and the lead tab 120 may be laid on the terminal member 160. The lead tab 120 and the terminal member 160 may closely contact each other by the through coupling member 181 that passes through the coupling holes 125 and 165 formed at the positions corresponding to the terminal member 160 and the lead tab 120 and is coupled to the coupling hole 165 of the terminal member 160. Since the through coupling member 181 is coupled to the terminal member 160 and passes through the lead tab 120, the lead tab 120 and the terminal member 160 may be coupled to each other.

The terminal member 160 may be formed of a metal material having high electrical conductivity, such as nickel (Ni), copper (Cu), aluminum (Al), etc., and may have a generally rectangular block shape. In one embodiment, the terminal member 160 may have a Ni-plated Cu block shape.

The coupling hole 165 for coupling to the lead tab 120 may be formed in the terminal member 160. The coupling hole 165 of the terminal member 160 is formed at a position corresponding to the coupling hole 125 of the lead tab 120. In the coupling of the terminal member 160 and the lead tab 120, for example, the terminal member 160 and the lead tab 120 are arranged to overlap with each other and are assembled to each other by inserting the through coupling member 181 in the coupling holes 125 and 165 formed at the corresponding positions of the terminal member 160 and the lead tab 120. In one embodiment, the through coupling member 181 is coupled to the thread formed on the coupling hole 165 of the terminal member 160, and the terminal member 160 and the lead tab 120 may be coupled to each other.

The coupling between the terminal member 160 and the lead tab 120 may be made concurrently (e.g., simultaneously) with the coupling between the frame case 150 and the battery unit 100. That is, in one embodiment, when the frame case 150 and the battery unit 100 are arranged to face each other, the frame case 150 and the battery unit 100 are arranged such that the first support portion 151 faces the battery cell 110, and the second support portion 152 faces the lead tab 120.

The second support portion 152, in one embodiment, is arranged facing the lead tab 120 with the terminal member 160 interposed therebetween. For example, while the terminal member 160 is fixed to the second support portion 152, the terminal member 160 and the lead tab 120 may be arranged facing each other. As the through coupling member 181 is coupled to the terminal member 160, the terminal member 160 and the lead tab 120 are coupled to each other. Also, as the through coupling member 181 is coupled to the terminal member 160 and passes through the lead tab 120, the battery unit 100 and the frame case 150 may be coupled to each other.

In other words, due to the coupling between the terminal member 160 and the lead tab 120, the frame case 150 to which the terminal member 160 is fixed and the battery unit 100 to which the lead tab 120 is fixed may be coupled to each other. However, the present invention is not limited thereto. For example, in another embodiment, a separate coupling structure for coupling between the frame case 150 and the battery unit 100 may be provided.

As described above, as the through coupling member 181 is coupled to the terminal member 160 while passing through the lead tab 120, a mechanical coupling between the frame case 150 and the battery unit 100 may be made.

In particular, in a mid- and large-sized battery of high capacity and high output, the thickness of a connection portion including the terminal member 160 and the lead tab 120 needs to be increased. Accordingly, the mechanical coupling using the through coupling member 181 is advantageous compared to another coupling method, such as thermal welding. For example, the thermal welding coupling method needs a high output heat source and may produce problems such as a low coupling strength and irregular distribution. The thermal welding coupling method also has a limited weldable thickness. According to an embodiment of the present invention, the through coupling member 181 may be a bolt structure, for example, that may couple the terminal member 160 and the lead tab 120 by a mechanical method.

Referring to FIG. 1, a surface (e.g., a lower surface) of the lead tab 120 makes surface contact with the terminal member 160. The lead tab 120 closely contacts the terminal member 160 according to a coupling pressure of the through coupling member 181. In one embodiment, a holder case 130 is placed on another surface (e.g., an upper surface) of the lead tab 120.

The holder case 130 prevents or substantially prevents electrically conductive members such as the lead tab 120 and the terminal member 160 from being exposed to the outside. By insulating the electrically conductive members from the outside, the holder case 130 prevents or reduces electrical interference by an external environment.

FIG. 4 is a bottom perspective view of the holder case 130. In one embodiment, an exterior of the holder case 130 may be formed of an insulation material. In one embodiment, a cover member 130a forming the exterior of the holder case 130 may be formed of an insulation resin material.

The holder case 130 may reduce electrical resistance of the connection portion and improved discharge efficiency by reinforcing an electrical connection state of the connection portion formed by the terminal member 160 and the lead tab 120. The holder case 130, in one embodiment, provides a uniform or substantially uniform surface pressure to forcibly press the lead tab 120 against the terminal member 160. Accordingly, a coupling force between the terminal member 160 and the lead tab 120 may be improved. For example, the lead tab 120 may be sandwiched between the terminal member 160 and the holder case 130 to closely contact each other, forming a firm and stable electrical connection therebetween.

The holder case 130, in one embodiment, reduces electrical resistance of a charge/discharge current by providing an additional conductive area. That is, in one embodiment, an inner portion of the holder case 130 contacting the lead tab 120 may include a conductive plate 130b that is formed of a metal material exhibiting high electrical conductivity. The battery pack 190, in one embodiment, includes a pair of the holder cases 130 coupled to the first and second lead tabs 121 and 122.

The holder case 130, in one embodiment, has a generally flat plate shape and includes one or more coupling holes 135 for passing the through coupling member 181 therethrough. The coupling holes 135 of the holder case 130 may be formed at positions corresponding to the coupling holes 125 of the lead tab 120. The through coupling member 181 for coupling the terminal member 160 and the lead tab 120 may pass through the coupling holes 135 of the holder case 130. In one embodiment, the terminal member 160, the lead tab 120, and the holder case 130 are all coupled to one another by the through coupling member 181. That is, as the through coupling member 181 (e.g., a same through coupling member 181) is coupled to the terminal member 160 and passes through the holder case 130 and the lead tab 120, an assembly process of the battery pack 190, as well as the battery pack 190 itself, may be simplified.

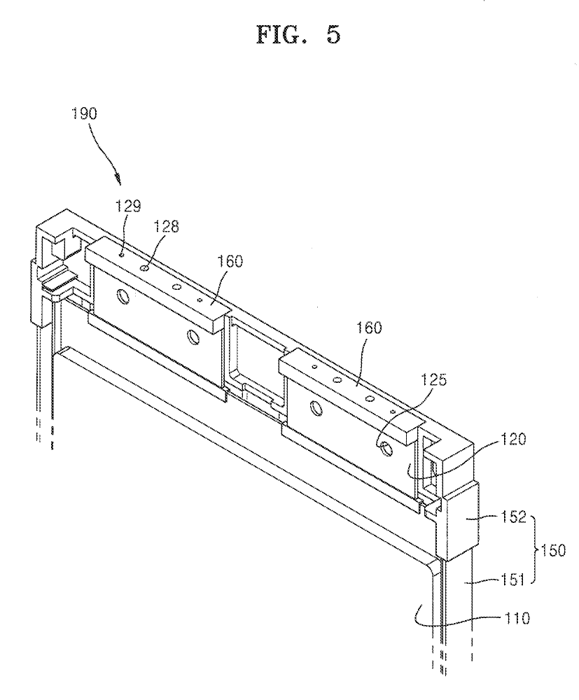

FIG. 5 is a perspective view showing an end of the battery pack 190 in an upright orientation, and in which the holder case 130 is not shown for clarity. Referring to FIG. 5, the terminal member 160 is coupled to the second support portion 152 of the frame case 150. For example, the terminal member 160 may be coupled to the second support portion 152 such that one surface of the terminal member 160 is exposed (e.g., the upper surface, as shown in FIG. 5).

A coupling structure 128 of a bus bar (not shown), as a structure to configure a mid- and large-sized battery of high capacity and high output by electrically coupling a plurality of the battery packs 190, may be formed on the exposed upper surface of the terminal member 160. In addition, an input/output portion 129 of a transfer path for signals and power with a control portion (not shown) for controlling the charge/discharge operation of the battery pack 190 or an external apparatus (not shown) may be formed on the exposed upper surface of the terminal member 160.

As described above, according to an embodiment of the present invention, a coupling force in a direction (e.g., a thickness direction) of the battery pack 190 is provided by the through coupling member 181 coupled to the coupling hole 165 of the terminal member 160. In one embodiment, even when the coupling structure formed on the terminal member 160 (e.g., the thread of the terminal member 160 to which the through coupling member 181 is coupled) is damaged, such as due to mechanical abrasion, auxiliary coupling devices provide a coupling force in a direction (e.g., the thickness direction) of the battery pack 190.

In one embodiment, the auxiliary coupling devices include the through coupling member 181 and a combination coupling member 182. In one embodiment, the through coupling member 181 is a bolt, and the combination coupling member 182 is a nut. However, the present invention is not limited thereto. That is, in other embodiments, any other coupling structure capable of passing through and being coupled to the coupling holes 125 and 165 formed in the lead tab 120 and the terminal member 160 may be used as the auxiliary coupling devices.

In one embodiment, the through coupling member 181 may be screw coupled to the terminal member 160, that is, to the thread formed on the coupling hole 165 of the terminal member 160. The thread formed on the coupling hole 165 of the terminal member 160 may be damaged as a long-term coupling state is maintained or mechanical interference and abrasion with the through coupling member 181 is generated due to an external force. Accordingly, a coupling force between the through coupling member 181 and the terminal member 160, which are matched in shape with each other, may become deteriorated.

Repair may be needed to reinforce the coupling state of the battery pack 190. According to embodiments of the present invention, maintenance and repairability are improved due to a structure that facilitates introduction of the auxiliary coupling devices.

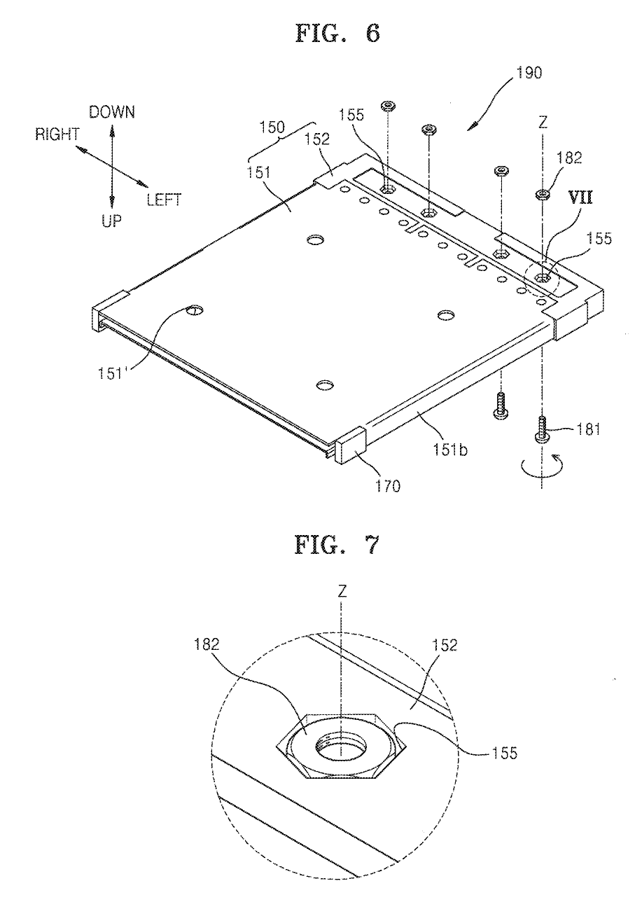

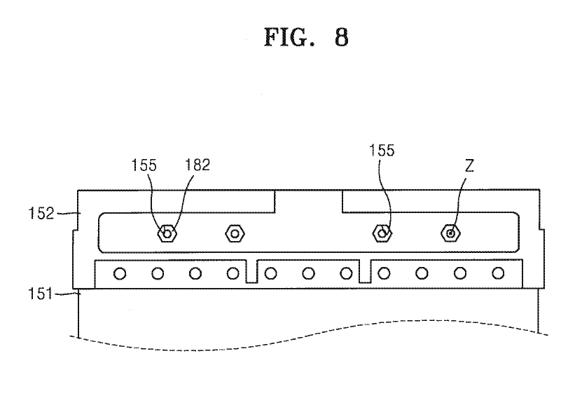

FIG. 6 is a partially exploded bottom perspective view of the battery pack 190. FIG. 7 is an enlarged bottom perspective view of the region VII of FIG. 6. FIG. 8 is a bottom view of a portion of the battery pack 190.

Referring to FIG. 6, in one embodiment, the auxiliary coupling devices are arranged on a same Z-axis along a direction (e.g., a thickness direction) of the battery pack 190. The auxiliary coupling device, in one embodiment, includes the through coupling member 181 and the combination coupling member 182 which are mechanically coupled with each other. The through coupling member 181, in one embodiment, sequentially passes through the lead tab 120, the terminal member 160, and the second support portion 152 which are arranged to be overlapped with one another and mechanically couples with the combination coupling member 182 arranged under the second support portion 152.

Since the through coupling member 181 and the combination coupling member 182 make a mechanical coupling with each other, the lead tab 120, the terminal member 160, and the second support portion 152 stacked between the through coupling member 181 and the combination coupling member 182 closely contact each other and are coupled to each other.

The through coupling member 181, in one embodiment, is inserted from above the second support portion 152 and makes a mechanical coupling with the combination coupling member 182 arranged under the second support portion 152. The through coupling member 181 and the combination coupling member 182 are coupled to each other through a relative coupling operation with respect to each other.

In one embodiment, the through coupling member 181 and the combination coupling member 182 are screw coupled to each other through relative rotation with respect to each other. In one embodiment, a thread in a spiral form (e.g., an external thread) is formed on an outer circumferential surface of the through coupling member 181 and a thread groove (e.g., an internal thread) may be formed on an inner circumferential surface of the combination coupling member 182 that corresponds to the thread of the through coupling member 181.

As illustrated in FIG. 6, in a state in which the through coupling member 181 and the combination coupling member 182 are arranged on the same axis (i.e. a same Z-axis), the through coupling member 181 and the combination coupling member 182 may be rotated relative to each other around a coupling axis (i.e. the Z-axis) so that a screw coupling is made as the thread and the thread groove are threadedly engaged with each other.

Referring to FIG. 7, in one embodiment, the combination coupling member 182 is recessed in the second support portion 152. That is, the combination coupling member 182 is inserted in the coupling hole 155 of the second support portion 152, and has a perimeter shape (e.g. a hexagonal perimeter shape) corresponding to a perimeter shape of the coupling hole 155, and is confined to closely contact an inner wall of the coupling hole 155.

In one embodiment, the combination coupling member 182 has a generally polyhedral exterior. The coupling hole 155 has a polyhedral shape that substantially matches the shape of the combination coupling member 182. For example, the combination coupling member 182 may have a hexagonal nut shape and the coupling hole 155 may be formed as a hole structure having a hexagonal shape. However, in other embodiments, the structures of the combination coupling member 182 and the coupling hole 155 engaging the combination coupling member 182 are not limited to the above descriptions.

However, a structure having a shape (e.g., a cylindrical shape) that allows relative rotation between the combination coupling member 182 and the second support portion 152, that is, a structure allowing slippage, would not be desirable for fixing the combination coupling member 182 in a rotational direction, and is not suitable for a rotational coupling structure such as a bolt-nut assembly.

In one embodiment, because the combination coupling member 182 and the coupling hole 155 are matched in shape with each other, the combination coupling member 182 is restrained by the second support portion 152 and the rotation in the coupling axis (Le. the Z-axis) is restricted so that slippage relative to each other is prevented or substantially prevented. Thus, the combination coupling member 182 does not slip and repair may be performed and facilitated by rotation of only the through coupling member 181.

The through coupling member 181 may provide a coupling force in a direction (e.g., the thickness direction) of the battery pack 190 through the coupling to the terminal member 160. According to embodiments of the present invention, when the thread formed on the coupling hole 165 of the terminal member 160 is damaged due to frictional abrasion caused by the through coupling member 181, as described further below, a repair using the through coupling member 181 and the combination coupling member 182 may be performed.

That is, in one embodiment, a hexagonal shape for recessing the combination coupling member 182 is provided in the surface of the coupling hole 155 of the second support portion 152 opposite the lead tab 120. After the combination coupling member 182 is fixedly inserted in the hexagonal shape of the coupling hole 155, the coupling of the through coupling member 181 may be performed. Since the combination coupling member 182 is fixed by being recessed in the coupling hole 155, the coupling of the through coupling member 181 and the combination coupling member 182 may be completed by the rotation of only the through coupling member 181. That is, in one embodiment, after the combination coupling member 182 is inserted in the coupling hole 155 and then the through coupling member 181 is rotated, the through coupling member 181 and the combination coupling member 182 are coupled to each other.

Since the coupling of the auxiliary coupling devices may be easily performed by the rotation of only the through coupling member 181, productivity in repair may be improved. For example, if the thread of the coupling hole 165 is abraded, the through coupling member 181 that provides a coupling force in a direction (e.g., the thickness direction) of the battery pack 190 by the coupling to the coupling hole 165, the thread formed on the coupling hole 165 may not provide a desired coupling force and may need repair.

Since, in one embodiment, a structure to recess the combination coupling member 182 is provided in the coupling hole 155 of the second support portion 152, and the combination coupling member 182 is inserted in the coupling hole 155, matching in shape with each other, slippage of the combination coupling member 182 may be prevented or substantially prevented and the coupling of the auxiliary coupling device may be made with the rotation of only the through coupling member 181.

The combination coupling member 182, in one embodiment, may be integrally formed with the second support portion 152 or, alternatively, may be inserted and assembled in the coupling hole 155 after the second support portion 152 is formed, such as when repair is needed. In one embodiment, the combination coupling member 182 may be integrally formed with the second support portion 152 through the injection molding of hetero-materials. That is, the combination coupling member 182 may be arranged in a mold (not shown) for molding the second support portion 152 and a raw material paste (not shown) for forming the second support portion 152 may be injected in the mold so that the combination coupling member 182 may be insert-injection-molded by being integrally buried, or recessed, in the second support portion 152.

In one embodiment, the combination coupling member 182 may be inserted and assembled in the coupling hole 155 of the second support portion 152 when repair is needed after the second support portion 152 is formed. That is, the combination coupling member 182 may be inserted and assembled in the coupling hole 155 when repair is desired. Thus, in one embodiment of a battery pack according to the present invention, the combination coupling member 182 may be omitted, or at least initially omitted before repair is desired. That is, in one embodiment, only the coupling hole 155 configured to recess the combination coupling member 182 may be initially present because the combination coupling member 182 may be inserted and assembled in the coupling hole 155 later when repair is desired.

In one embodiment, in a rotational coupling structure such as a bolt-nut assembly, the combination coupling member 182 capable of preventing or substantially preventing rotation by the restriction of the second support portion 152 is sufficient. For example, it is not needed to restrict a movement in a direction of insertion in the coupling hole 155 of the second support portion 152 or a movement in a direction opposite the direction of insertion in the coupling hole 155. In one embodiment, the combination coupling member 182 may be inserted in the coupling hole 155 of the second support portion 152 only during repair. The combination coupling member 182 may be fixedly located in the coupling axis (i.e. the Z-axis) through the coupling to the through coupling member 181.

In consideration of the above, when the combination coupling member 182 is recessed in the second support portion 152 or the combination coupling member 182 matches the second support portion 152 in shape, it is not necessary that the combination coupling member 182 is completely restricted by the second support portion 152.

In the embodiment illustrated in the drawings, although a rotational coupling structure such as a bolt-nut assembly is depicted as the auxiliary coupling device, the present invention is not limited thereto. That is, in addition to the rotational coupling structure, a translational coupling structure in which the through coupling member 181 is forcibly inserted in the combination coupling member 182 in a translational direction, for example, in the coupling axis (i.e. the Z-axis). However, in this case, the second support portion 152 may restrict the translational movement of the combination coupling member 182.

According to embodiments of the present invention, a coupling method collectively or mechanically couples elements of a battery pack in a direction (e.g., a thickness direction) of the battery pack by penetrating them, and may be advantageously applied to a battery pack of high capacity and high output.

Further, according to embodiments of the present invention, when a coupling device for collectively coupling the constituent elements in a direction (e.g., a thickness direction) of the battery pack is damaged or a coupling force is weakened so that repair is needed, an auxiliary coupling device may be easily introduced so that a combination coupling member forming a part of the auxiliary coupling device may be recessed or buried. Thus, rotation of the combination coupling member may be restricted, and the coupling of the auxiliary coupling device may be facilitated by the rotation of only the through coupling member forming a pair with the combination coupling member.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof. Descriptions of features or aspects within each embodiment should typically be considered as available for other similar features or aspects in other embodiments.

What is claimed is:

1. A battery pack comprising:
a battery unit comprising a battery cell and a lead tab extending from the battery cell;
a frame case supporting the battery unit and comprising a first support portion supporting the battery cell and a second support portion supporting the lead tab; and
a first coupling member passing through the lead tab and extending toward the second support portion,
wherein a coupling hole accommodating the first coupling member is formed in the second support portion, the coupling hole being configured to receive a second coupling member that is mechanically coupleable to the first coupling member.

2. The battery pack of claim 1, wherein the first coupling member has a rotational coupling structure that is coupleable to the second coupling member by rotation with respect to a coupling axis.

3. The battery pack of claim 2, wherein the coupling hole has a polygonal shape to restrict rotation of the second coupling member.

4. The battery pack of claim 1, wherein the coupling hole has a polygonal shape corresponding to a shape of the second coupling member.

5. The battery pack of claim 4, wherein the coupling hole has a hexagonal shape.

6. The battery pack of claim 1, further comprising a terminal member and a holder case, respectively contacting opposite surfaces of the lead tab, and arranged on the second support portion,
wherein the first coupling member is insertable in the coupling hole of the second support portion by passing through the holder case, the lead tab, and the terminal member.

7. The battery pack of claim 6, wherein the first coupling member extends to sequentially pass through the holder case, the lead tab, and the terminal member.

8. The battery pack of claim 1,
wherein the first support portion comprises a metal, and the second support portion comprises a resin-based material, and
wherein the first and second support portions are integrally formed with each other.

9. A battery pack comprising:
a battery unit comprising a battery cell and a lead tab extending from the battery cell;
a frame case supporting the battery unit and comprising a first support portion supporting the battery cell and a second support portion supporting the lead tab; and
a first coupling member passing through the lead tab and pressing the lead tab toward the second support portion,
wherein a coupling hole accommodating the first coupling member is formed in the second support portion, the coupling hole having a shape corresponding to a shape of a second coupling member that is mechanically coupleable to the first coupling member.

10. The battery pack of claim 9, wherein the first coupling member has a rotational coupling structure that is coupleable to the second coupling member by rotation with respect to a coupling axis.

11. The battery pack of claim 10, wherein the coupling hole has a polygonal shape to restrict rotation of the second coupling member.

12. The battery pack of claim 9, wherein the coupling hole has a hexagonal shape.

13. The battery pack of claim 9, further comprising a terminal member and a holder case, respectively contacting opposite surfaces of the lead tab, and arranged on the second support portion,
wherein the first coupling member is insertable in the coupling hole of the second support portion by passing through the holder case, the lead tab, and the terminal member.

14. The battery pack of claim 13, wherein the first coupling member extends to sequentially pass through the holder case, the lead tab, and the terminal member.

15. The battery pack of claim 9,
wherein the first support portion comprises a metal, and the second support portion comprises a resin-based material, and
wherein the first and second support portions are integrally formed with each other.
